(19) United States
(12) Patent Application Publication
(10) Pub. No.: US 2026/0177653 A1
(43) Pub. Date: Jun. 25, 2026

(54) METHOD FOR PERFORMING INDOOR LOCATION ESTIMATION WITH ANGLE OF ARRIVAL INFORMATION IN WIRELESS COMMUNICATION SYSTEM, AND ASSOCIATED APPARATUS

(71) Applicant: MEDIATEK INC., Hsinchu City (TW)

(72) Inventor: Chi-Shiang Kuo, Hsinchu City (TW)

(73) Assignee: MEDIATEK INC., Hsinchu City (TW)

(21) Appl. No.: 18/988,919

(22) Filed: Dec. 20, 2024

(51) Int. Cl. G01S 5/02

(52) U.S. Cl. CPC G01S 5/02521; G01S 2205/02

(57) ABSTRACT

A method for performing indoor location estimation with angle of arrival (AoA) information in a wireless communication system and associated apparatus such as a wireless transceiver device are provided, where the wireless transceiver device is capable of detecting at least one signal from at least one other device in the wireless communication system. The method may include: in an online positioning phase among multiple phases of the wireless transceiver device, detecting, by using an antenna array of the wireless transceiver device, an AoA of any signal among the at least one signal from the at least one other device to determine the AoA information corresponding to the at least one other device; and in the online positioning phase, based on an AoA-related database which is established in an offline calibration phase among the multiple phases, estimating an indoor location of the wireless transceiver device according to the AoA information.

### BACKGROUND

The present invention is related to communication control, and more particularly, to a method for performing indoor location estimation with angle of arrival (AoA) information in a wireless communication system, and associated apparatus such as a wireless transceiver device in the wireless communication system.

According to the related art, a first indoor location solution may be arranged to determine the indoor location of a station (STA) when there are three or more access points (APs) that support round trip time (RTT) measurement, and the three or more APs may be implemented according to the Institute of Electrical and Electronics Engineers (IEEE) 802.11mc/az standards. However, it seems that there are few options for IEEE 802.11mc/az AP products on the market. As a result, the first indoor location solution may be impractical for most users. Another indoor location solution in the related art may be arranged to determine the indoor location of a STA in a relatively complicated manner with the aid of conventional APs, having no need to install any IEEE 802.11mc/az AP, but the low accuracy thereof seems to be unacceptable for most users. Thus, a novel method and associated architecture are needed for solving the problems without introducing any side effect or in a way that is less likely to introduce a side effect.

### SUMMARY

It is an objective of the present invention to provide a method for performing indoor location estimation with AoA information in a wireless communication system, and associated apparatus such as a wireless transceiver device (e.g., a non-access-point (non-AP) STA device) in the wireless communication system, in order to solve the above-mentioned problems.

At least one embodiment of the present invention provides a method for performing indoor location estimation with AoA information in a wireless communication system, where a wireless transceiver device is capable of detecting at least one signal from at least one other device in the wireless communication system. For example, the method may comprise: in an online positioning phase among multiple phases of the wireless transceiver device, detecting, by using an antenna array of the wireless transceiver device, an AoA of any signal among the at least one signal from the at least one other device to determine the AoA information corresponding to the at least one other device; and in the online positioning phase, based on an AoA-related database, estimating an indoor location of the wireless transceiver device according to the AoA information, wherein the AoA-related database is established in an offline calibration phase, the offline calibration phase prior to the online positioning phase, among the multiple phases of the wireless transceiver device.

At least one embodiment of the present invention provides a wireless transceiver device, for performing indoor location estimation with AoA information in a wireless communication system, where the wireless transceiver device is one of multiple devices within the wireless communication system such as that mentioned above. The wireless transceiver device may comprise a processing circuit that is arranged to control operations of the wireless transceiver device. The wireless transceiver device may further comprise at least one communication control circuit that is coupled to the processing circuit and arranged to perform communication control, wherein the aforementioned at least one communication control circuit is arranged to perform wireless communication operations within the wireless communication system for the wireless transceiver device, and more particularly, perform the wireless communication operations with one or more other devices among the multiple devices for the wireless transceiver device. In addition, the wireless transceiver device is capable of detecting at least one signal from at least one other device in the wireless communication system. For example, in an online positioning phase among multiple phases of the wireless transceiver device, the wireless transceiver device is arranged to detect, by using an antenna array of the wireless transceiver device, an AoA of any signal among the at least one signal from the at least one other device to determine the AoA information corresponding to the at least one other device; and in the online positioning phase, based on an AoA-related database, the wireless transceiver device is arranged to estimate an indoor location of the wireless transceiver device according to the AoA information, wherein the AoA-related database is established in an offline calibration phase, the offline calibration phase prior to the online positioning phase, among the multiple phases of the wireless transceiver device.

It is an advantage of the present invention that, through proper design, the method of the present invention, as well as the associated apparatus such as the wireless transceiver device, can maintain sufficient indoor location accuracy for the user, and more particularly, can reach a centimeter-level accuracy in real time with the aid of one or more conventional APs, having no need to install any IEEE 802.11mc/az AP. For example, the location error of the first indoor location solution using the IEEE 802.11mc/az APs may be less than or equal to one meter (m), and the location error of the other indoor location solution in the related art may be less than or equal to ten meters, and therefore, the indoor location accuracy of the method and the associated apparatus of the present invention is much higher than that of the solutions in the related art. In addition, the method of the present invention and the associated apparatus such as the wireless transceiver device can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2 illustrates, in the lower half part thereof, an AoA-based calibration and positioning control scheme of a method for performing indoor location estimation with AoA information in a wireless communication system according to an embodiment of the present invention, where a received signal strength (RSS)-based calibration and positioning control scheme may be illustrated in the upper half part of FIG. 2 for better comprehension.

FIG. 3 illustrates the offline calibration of the AoA-based calibration and positioning control scheme shown in FIG. 2 according to an embodiment of the present invention.

FIG. 4 illustrates the online positioning of the AoA-based calibration and positioning control scheme shown in FIG. 2 according to an embodiment of the present invention.

FIG. 5 illustrates an AoA calculation control scheme of the method according to an embodiment of the present invention.

FIG. 6A illustrates an AoA information generation control scheme of the method according to an embodiment of the present invention.

FIG. 6B illustrates, in the sub-diagrams (a) and (b) thereof, some examples of respective operations of multiple predetermined algorithms applicable to a first-peak finding operation of the AoA information generation control scheme shown in FIG. 6A, and further illustrates, in the sub-diagram (c) thereof, another example of the first-peak finding operation.

FIG. 7 illustrates a channel state information (CSI) model involved with the method according to an embodiment of the present invention.

FIG. 8 illustrates some key features of a fusion indoor location system involved with the method according to an embodiment of the present invention.

FIG. 9 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

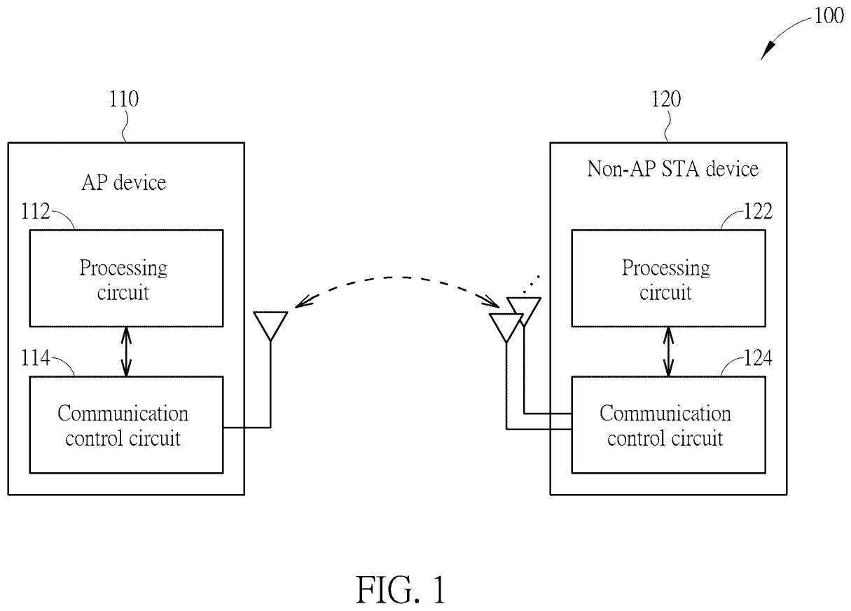

FIG. 1 is a diagram of a wireless communication system 100 according to an embodiment of the present invention. For better comprehension, the wireless communication system 100, as well as any wireless transceiver device #k among multiple wireless transceiver devices #1, . . . and #K therein, may be compatible or backward-compatible to one or more versions of the Institute of Electrical and Electronics Engineers (IEEE) 802.11 standards, but the present invention is not limited thereto. Among the multiple wireless transceiver devices #1, . . . and #K within the wireless communication system 100, a wireless transceiver device may be implemented as an AP device 110, and another wireless transceiver device may be implemented as a non-AP STA device 120, but the present invention is not limited thereto. For example, two or more wireless transceiver devices among the multiple wireless transceiver devices #1, . . . and #K may be implemented as multiple AP devices {110}. In another example, two or more wireless transceiver devices among the multiple wireless transceiver devices #1, . . . and #K may be implemented as multiple non-AP STA devices {120}. In some examples, two or more wireless transceiver devices among the multiple wireless transceiver devices #1, . . . and #K may be implemented as multiple AP devices {110}, and two or more other wireless transceiver devices among the multiple wireless transceiver devices #1, . . . and #K may be implemented as multiple non-AP STA devices {120}.

As shown in FIG. 1, the AP device 110 may comprise a processing circuit 112, at least one communication control circuit (e.g., one or more communication control circuits), which may be collectively referred to as the communication control circuit 114, and at least one antenna (e.g., one or more antennas) of the communication control circuit 114, and the non-AP STA device 120 may comprise a processing circuit 122, at least one communication control circuit (e.g., one or more communication control circuits), which may be collectively referred to as the communication control circuit 124, and at least two antennas (e.g., two or more antennas) of the communication control circuit 124. In the architecture shown in FIG. 1, the processing circuit 112 can be arranged to control operations of the AP device 110, and the communication control circuit 114 can be arranged to perform communication control, and more particularly, perform wireless communication operations with the network (or at least one other device therein such as the non-AP STA device 120) for the AP device 110. In addition, the processing circuit 122 can be arranged to control operations of the non-AP STA device 120, and the communication control circuit 124 can be arranged to perform communication control, and more particularly, perform wireless communication operations with the network (or at least one other device therein such as the AP device 110) for the non-AP STA device 120.

According to some embodiments, the processing circuit 112 can be implemented by way of at least one processor/microprocessor, at least one random access memory (RAM), at least one bus, etc., and the communication control circuit 114 can be implemented by way of at least one wireless network control circuit and at least one wired network control circuit, but the present invention is not limited thereto. Examples of the AP device 110 may include, but are not limited to: a Wi-Fi router. In addition, the processing circuit 122 can be implemented by way of at least one processor/microprocessor, at least one RAM, at least one bus, etc., and the communication control circuit 124 can be implemented by way of at least one wireless network control circuit, but the present invention is not limited thereto. Examples of the non-AP STA device 120 may include, but are not limited to: a multifunctional mobile phone, a laptop computer, an all-in-one computer and a wearable device.

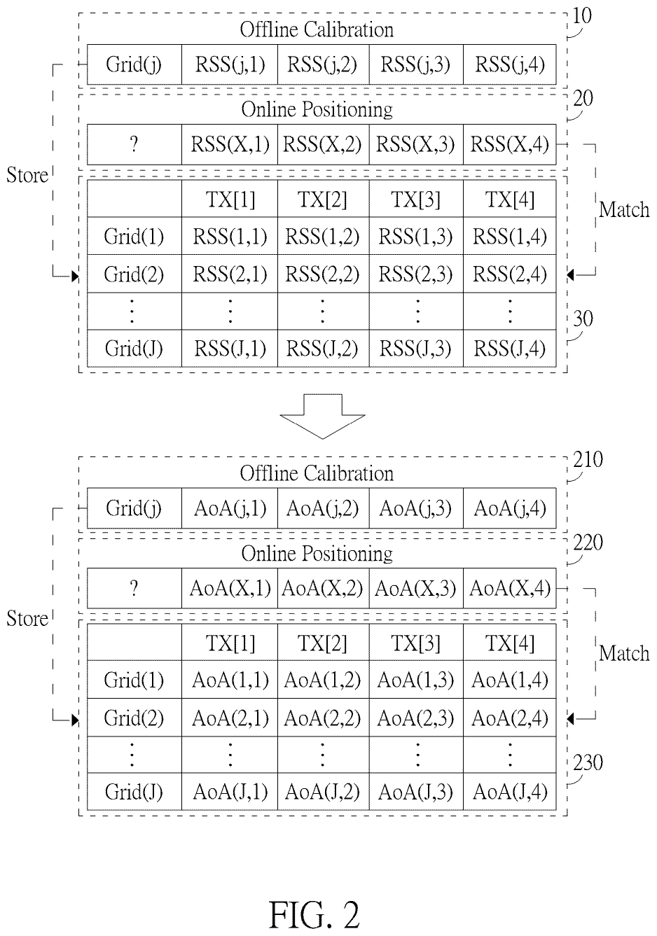

FIG. 2 illustrates, in the lower half part thereof, an AoA-based calibration and positioning control scheme of a method for performing indoor location estimation with AoA information in a wireless communication system according to an embodiment of the present invention, where an RSS-based calibration and positioning control scheme may be illustrated in the upper half part of FIG. 2 for better comprehension. Assume that one or more functions of the wireless communication system 100 may be temporarily disabled to allow the wireless transceiver device #k (e.g., the non-AP STA device 120) among the wireless transceiver devices #1, . . . and #K therein to operate according to the RSS-based calibration and positioning control scheme shown in the upper half part of FIG. 2, but the present invention is not limited thereto. Based on the RSS-based calibration and positioning control scheme, the wireless transceiver device #k such as the non-AP STA device 120 may determine the indoor location thereof according to RSS levels or received signal strength indicators (RSSIs) with the aid of at least one other device (e.g., one or more other devices) within the wireless communication system 100, such as at least one AP device 110 (e.g., one or more AP devices {110}), having no need to implement the aforementioned at least one AP device 110 according to the IEEE 802.11mc/az standards. For example, assuming that the AP device count D of the aforementioned at least one AP device 110 acting as at least one transmitter TX[i] (e.g., one or more transmitters {TX[i]|i=1, . . . , D}) is equal to four, the non-AP STA device 120 may perform offline calibration 10 to obtain a set of RSSs {RSS(j, 1), RSS(j, 2), RSS(j, 3), RSS(j, 4)} of four signals from the four AP devices {110} acting as the four transmitters {TX[1], TX[2], TX[3], TX[4]} with respect to any predetermined indoor location Grid(j) among J predetermined indoor locations {Grid(1), Grid(2), . . . , Grid(J)} to establish an RSS-related database 30 in advance, and perform online positioning 20 based on the RSS-related database 30 to determine an unknown location/position (labeled “?” for brevity) of the non-AP STA device 120 at a current time point, such as a current indoor location X of the non-AP STA device 120 at the current time point, according to a set of RSSs {RSS(X, 1), RSS(X, 2), RSS(X, 3), RSS(X, 4)} of four other signals from the four AP devices acting as the four transmitters {TX[1], TX[2], TX[3], TX[4]}. Although the non-AP STA device 120 operating according to the RSS-based calibration and positioning control scheme may obtain the current indoor location X thereof without using any IEEE 802.11mc/az AP, the indoor location accuracy may be insufficient for practical use.

As shown in the lower half part of FIG. 2, the wireless communication system 100 (or the wireless transceiver device #k therein such as the non-AP STA device 120) may operate according to the AoA-based calibration and positioning control scheme for establishing an AoA-related database 230 in an offline calibration phase (e.g., the offline calibration phase prior to the online positioning phase) among multiple phases of the wireless transceiver device #k and performing positioning in an online positioning phase among the multiple phases, in order to achieve a better overall performance, and the associated operations may comprise:
(1) in the online positioning phase, the wireless transceiver device #k (e.g., the non-AP STA device 120) may detect, by using an antenna array of the wireless transceiver device #k, an AoA of any signal among at least one signal from the aforementioned at least one other device (e.g., the aforementioned at least one AP device 110) to determine the AoA information corresponding to the aforementioned at least one other device; and
(2) in the online positioning phase, based on the AoA-related database 230 which is established in the offline calibration phase, the wireless transceiver device #k (e.g., the non-AP STA device 120) may estimate an indoor location (e.g., the current indoor location X) of the wireless transceiver device #k according to the AoA information;
where the AoA-related database may be established in the offline calibration phase in advance for being used by the wireless transceiver device #k in the online positioning phase. In addition, the aforementioned at least one other device may comprise multiple other devices such as the four AP devices {110} acting as the four transmitters {TX[1], TX[2], TX[3], TX[4]}, and the aforementioned at least one signal may comprise multiple signals from the multiple other devices that are detected in the online positioning phase, but the present invention is not limited thereto. According to some embodiments, the number of the aforementioned at least one other device, such as the AP device count D of the aforementioned at least one AP device 110 (or the transmitter count D of the one or more transmitters {TX[i]|i=1, . . . , D}), and the signal count D of the aforementioned at least one signal may vary.

In a situation where D>1, the AoA information may comprise one or a combination of respective angles of arrival (AoAs) of the multiple signals and a set of features extracted from the respective AoAs of the multiple signals. More particularly, the AoA-related database 230 may be established with respect to multiple predetermined indoor locations such as the J predetermined indoor locations {Grid(1), Grid(2), . . . , Grid(J)}, and regarding any predetermined indoor location among the multiple predetermined indoor locations, such as the aforementioned any predetermined indoor location Grid(j) among the J predetermined indoor locations {Grid(1), Grid(2), . . . , Grid(J)}, the AoA-related database 230 may comprise one or a combination of respective AoAs of multiple first signals from the multiple other devices (e.g., the four AP devices {110} acting as the four transmitters {TX[1], TX[2], TX[3], TX[4]}) and a set of features extracted from the respective AoAs of the multiple first signals, where the multiple signals detected in the online positioning phase may represent multiple second signals. For example, if the AoA-related database 230 comprises the respective AoAs of the multiple first signals, the AoA information may comprise the respective AoAs of the multiple second signals; and if the AoA-related database 230 comprises the set of features extracted from the respective AoAs of the multiple first signals, the AoA information may comprise a set of features extracted from the respective AoAs of the multiple second signals. This is for illustrative purposes only, and is not meant to be a limitation of the present invention. When D≥1, the AoA information may comprise one or a combination of the AoA of the aforementioned any signal and a feature extracted from the AoA of the aforementioned any signal. More particularly, the AoA-related database 230 may be established with respect to the multiple predetermined indoor locations such as the J predetermined indoor locations {Grid(1), Grid(2), . . . , Grid(J)}, and regarding the aforementioned any predetermined indoor location among the multiple predetermined indoor locations, such as the aforementioned any predetermined indoor location Grid(j) among the J predetermined indoor locations {Grid(1), Grid(2), . . . , Grid(J)}, the AoA-related database 230 may comprise one or a combination of at least one AoA of at least one first signal from the aforementioned at least one other device (e.g., the aforementioned at least one AP device 110 acting as the aforementioned at least one transmitter TX[i]) and at least one feature extracted from the aforementioned at least one AoA of the aforementioned at least one first signal, where the aforementioned at least one signal detected in the online positioning phase may represent at least one second signal. For example, if the AoA-related database 230 comprises the aforementioned at least one AoA of the aforementioned at least one first signal, the AoA information may comprise at least one AoA of the aforementioned at least one second signal; and if the AoA-related database 230 comprises the aforementioned at least one feature extracted from the aforementioned at least one AoA of the aforementioned at least one first signal, the AoA information may comprise at least one feature extracted from the aforementioned at least one AoA of the aforementioned at least one second signal.

For better comprehension, the AoA-based calibration and positioning control scheme may be illustrated with the case of D=4, such as the case in which the AoA-related database 230 comprises the respective AoAs {AoA(j, 1), AoA(j, 2), AoA(j, 3), AoA(j, 4)} (e.g., the j^{th} set of AoAs {AoA(j, 1), AoA(j, 2), AoA(j, 3), AoA(j, 4)} among the J sets of AoAs {{AoA(1, 1), AoA(1, 2), AoA(1, 3), AoA(1, 4)}, {AoA(2, 1), AoA(2, 2), AoA(2, 3), AoA(2, 4)}, . . . , {AoA(J, 1), AoA(J, 2), AoA(J, 3), AoA(J, 4)}}) of four first signals from the four AP devices {110} acting as the four transmitters {TX[1], TX[2], TX[3], TX[4]} and the AoA information comprises the respective AoAs {AoA(X, 1), AoA(X, 2), AoA(X, 3), AoA(X, 4)} of four second signals from the four AP devices {110} acting as the four transmitters {TX[1], TX[2], TX[3], TX[4]}. The non-AP STA device 120 may perform offline calibration 210 to obtain a set of AoAs {AoA(j, 1), AoA(j, 2), AoA(j, 3), AoA(j, 4)} of the four first signals from the four AP devices {110} acting as the four transmitters {TX[1], TX[2], TX[3], TX[4]} with respect to the aforementioned any predetermined indoor location Grid(j) among the J predetermined indoor locations {Grid(1), Grid(2), . . . , Grid(J)}, for being stored into the AoA-related database 230 to establish the AoA-related database 230 in the offline calibration phase, and perform online positioning 220 based on the AoA-related database 230 in the online positioning phase to determine an unknown location/position (labeled “?” for brevity) of the non-AP STA device 120 at a current time point, such as a current indoor location X of the non-AP STA device 120 at the current time point, according to the set of AoAs {AoA(X, 1), AoA(X, 2), AoA(X, 3), AoA(X, 4)} of the four second signals from the four AP devices {110} acting as the four transmitters {TX[1], TX[2], TX[3], TX[4]}. For example, when the indoor location count J of the J predetermined indoor locations {Grid(1), Grid(2), . . . , Grid(J)} is large enough, the non-AP STA device 120 may find, from the J sets of AoAs {{AoA(1, 1), AoA(1, 2), AoA(1, 3), AoA(1, 4)}, {AoA(2, 1), AoA(2, 2), AoA(2, 3), AoA(2, 4)}, . . . , {AoA(J, 1), AoA(J, 2), AoA(J, 3), AoA(J, 4)}}, a set of AoAs that matches the set of AoAs {AoA(X, 1), AoA(X, 2), AoA(X, 3), AoA(X, 4)} (labeled “Match” for brevity), and determine the current indoor location X to be equal to the predetermined indoor location corresponding to the found set of AoAs, but the present invention is not limited thereto. According to some embodiments, it is unnecessary to operate with the indoor location count J being equal to a large value. For example, based on the AoA-related database 230, the non-AP STA device 120 may determine the current indoor location X thereof according to the AoA information such as the set of AoAs {AoA(X, 1), AoA(X, 2), AoA(X, 3), AoA(X, 4)} by using one or more predetermined algorithms, interpolation and/or extrapolation.

According to some embodiments, the non-AP STA device 120 may extract a set of features {FAoA(j, 1), FAoA(j, 2), . . . , FAoA(j, R)} from the set of AoAs {AoA(j, 1), AoA(j, 2), . . . , AoA(j, D)} with respect to the aforementioned any predetermined indoor location Grid(j) among the J predetermined indoor locations {Grid(1), Grid(2), . . . , Grid(J)} to establish the AoA-related database 230 in the offline calibration phase, to make the AoA-related database 230 comprise J sets of features (or J feature sets) {{FAoA(1, 1), FAoA(1, 2), . . . , FAoA(1, R)}, {FAoA(2, 1), FAoA(2, 2), . . . , FAoA(2, R)}, . . . , {FAoA(J, 1), FAoA(J, 2), . . . , FAoA(J, R)}} respectively corresponding to the J sets of AoAs {{AoA(1, 1), AoA(1, 2), . . . , AoA(1, D)}, {AoA(2, 1), AoA(2, 2), . . . , AoA(2, D)}, . . . , {AoA(J, 1), AoA(J, 2), . . . , AoA(J, D)}}, where the feature count R of each feature set among the J feature sets may be a positive integer, and the AP device count D of the D AP devices {110} (or the transmitter count D of the transmitters {TX[i]|i=1, . . . , D}) may also be a positive integer. For example, the feature count R of each feature set among the J feature sets may be less than the AP device count D of the D AP devices {110}. In addition, the non-AP STA device 120 may perform the online positioning 220 based on the AoA-related database 230 in the online positioning phase, and more particularly, extract a set of features {FAoA(X, 1), FAoA(X, 2), . . . , FAoA(X, R)} from the set of AoAs {AoA(X, 1), AoA(X, 2), . . . , AoA(X, D)} to obtain the set of features {FAoA(X, 1), FAoA(X, 2), . . . , FAoA(X, R)} corresponding to the set of AoAs {AoA(X, 1), AoA(X, 2), . . . , AoA(X, D)}. Based on the AoA-related database 230 which comprises the J sets of features {{FAoA(1, 1), FAoA(1, 2), . . . , FAoA(1, R)}, {FAoA(2, 1), FAoA(2, 2), . . . , FAoA(2, R)}, . . . , {FAoA(J, 1), FAoA(J, 2), . . . , FAoA(J, R)}}, the non-AP STA device 120 may determine the current indoor location X of the non-AP STA device 120 at the current time point according to the set of features {FAoA(X, 1), FAoA(X, 2), . . . , FAoA(X, R)}. For brevity, similar descriptions for these embodiments are not repeated in detail here.

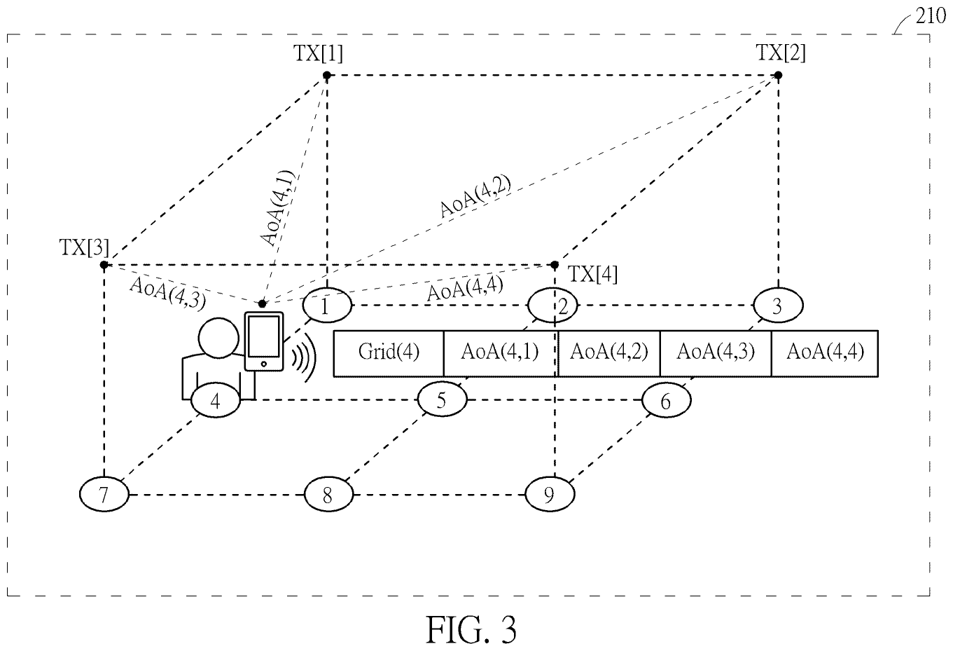

FIG. 3 illustrates the offline calibration 210 of the AoA-based calibration and positioning control scheme shown in FIG. 2 according to an embodiment of the present invention, where the non-AP STA device 120 may be implemented as the multifunctional mobile phone, and may be held by the user thereof. The J predetermined indoor locations {Grid(1), Grid(2), . . . , Grid(J)} may comprise nine predetermined indoor locations {Grid(1), Grid(2), Grid(3), Grid(4), Grid(5), Grid(6), Grid(7), Grid(8), Grid(9)}, which may be respectively labeled as their indoor location indices {1, 2, 3, 4, 5, 6, 7, 8, 9} on a predetermined plane (e.g., a plane of a certain floor) within a predetermined space (e.g., the space for which the AoA-related database 230 is established) for brevity. As shown in FIG. 3, the respective indoor location indices {1, 2, 3, 4, 5, 6, 7, 8, 9} of the predetermined indoor locations {Grid(1), Grid(2), Grid(3), Grid(4), Grid(5), Grid(6), Grid(7), Grid(8), Grid(9)} may be arranged as a three-by-three array {{1, 2, 3}, {4, 5, 6}, {7, 8, 9}} on a grid of points, indicating that the predetermined indoor locations {Grid(1), Grid(2), Grid(3), Grid(4), Grid(5), Grid(6), Grid(7), Grid(8), Grid(9)} may be the grid point locations {{Grid(1), Grid(2), Grid(3)}, {Grid(4), Grid(5), Grid(6)}, {Grid(7), Grid(8), Grid(9)}} of the grid of points, but the present invention is not limited thereto. According to some embodiments, the arrangement of the J predetermined indoor locations {Grid(1), Grid(2), . . . , Grid(J)} such as the predetermined indoor locations {Grid(1), Grid(2), Grid(3), Grid(4), Grid(5), Grid(6), Grid(7), Grid(8), Grid(9)} may vary. In addition, taking the case of j=4 as an example, the non-AP STA device 120 may perform the offline calibration 210 to obtain the set of AoAs {AoA(4, 1), AoA(4, 2), AoA(4, 3), AoA(4, 4)} of the four first signals from the four AP devices {110} acting as the four transmitters {TX[1], TX[2], TX[3], TX[4]} with respect to the predetermined indoor location Grid(4), for being stored into the AoA-related database 230 to establish the AoA-related database 230 in the offline calibration phase. For brevity, similar descriptions for this embodiment are not repeated in detail here.

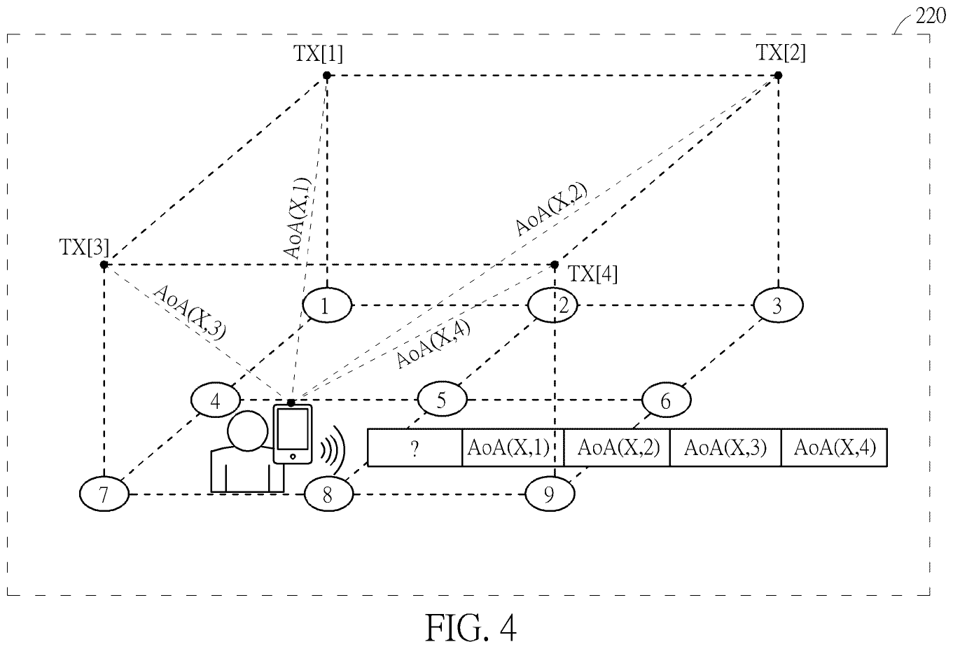

FIG. 4 illustrates the online positioning 220 of the AoA-based calibration and positioning control scheme shown in FIG. 2 according to an embodiment of the present invention, where the non-AP STA device 120 may be implemented as the multifunctional mobile phone, and may be held by the user thereof. The J predetermined indoor locations {Grid(1), Grid(2), . . . , Grid(J)} may comprise the aforementioned nine predetermined indoor locations {Grid(1), Grid(2), Grid(3), Grid(4), Grid(5), Grid(6), Grid(7), Grid(8), Grid(9)}, which may be respectively labeled as their indoor location indices {1, 2, 3, 4, 5, 6, 7, 8, 9} on the predetermined plane within the predetermined space for brevity. Taking the case of j=4 as an example, the non-AP STA device 120 may perform the online positioning 220 based on the AoA-related database 230 in the online positioning phase to determine the unknown location/position (labeled “?” for brevity) of the non-AP STA device 120 at the current time point, such as the current indoor location X of the non-AP STA device 120 at the current time point, according to the set of AoAs {AoA(X, 1), AoA(X, 2), AoA(X, 3), AoA(X, 4)} of the four second signals from the four AP devices {110} acting as the four transmitters {TX[1], TX[2], TX[3], TX[4]}. For brevity, similar descriptions for this embodiment are not repeated in detail here.

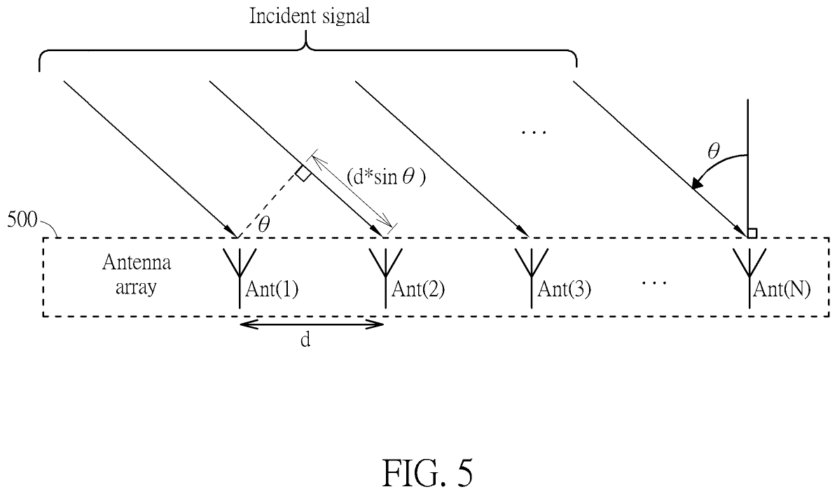

FIG. 5 illustrates an AoA calculation control scheme of the method according to an embodiment of the present invention, where the antenna array 500 may be taken as an example of the antenna array of the wireless transceiver device #k such as the non-AP STA device 120. The antenna array 500 may comprise multiple antennas {Ant( )} such as N antennas {Ant(1), Ant(2), Ant(3), . . . , Ant(N)}, having a common distance d between any two adjacent antennas {Ant( )} (e.g., the first two antennas {Ant(1), Ant(2)}) among the N antennas {Ant(1), Ant(2), Ant(3), . . . , Ant(N)}, but the present invention is not limited thereto. According to some embodiments, the antenna count N of the N antennas {Ant(1), . . . , Ant(N)}, the arrangement of the N antennas {Ant(1), . . . , Ant(N)}, and/or the distance d between two adjacent antennas {Ant( )} among the N antennas {Ant(1), . . . , Ant(N)} may vary. The incident signal having the incident angle θ with respect to the normal vector of the plane above the antenna array 500 may be illustrated as the arrows depicted with parallel lines above the N antennas {Ant(1), . . . , Ant(N)}, for indicating that the incident signal may arrive at the N antennas {Ant(1), . . . , Ant(N)} at different time points (or in different phases). Taking the first two antennas {Ant(1), Ant(2)} as an example, when reaching the antenna Ant(1), the incident signal still have a distance (d*sin(θ)) to reach the antenna Ant(2). The phase shift ΔΦ between two adjacent antennas {Ant( )} may be calculated as follows:

$$ΔΦ = 2 π f Δ t = 2 π f ( ( d * sin ( θ ) ) / c ) = 2 π d ( sin ( θ ) / λ ) ;$$

where λ=(c/f), “θ” may represent the AoA of the incident signal, “d” may represent the distance between the two adjacent antennas {Ant( )}, “f” may represent the frequency of the incident signal, and “λ” may represent the wavelength of the incident signal. For brevity, similar descriptions for this embodiment are not repeated in detail here.

According to some embodiments, during detecting the AoA of the aforementioned any signal among the aforementioned at least one signal from the aforementioned at least one other device to determine the AoA information corresponding to the aforementioned at least one other device, the wireless transceiver device #k (e.g., the non-AP STA device 120) may find respective first peaks of the multiple antennas {Ant( )} of the antenna array 500 since a first detection start time point (e.g., a time point at which the wireless transceiver device #k such as the non-AP STA device 120 starts to detect the AoA), and find a phase shift between at least two first peaks of at least two antennas {Ant( )} among the multiple antennas {Ant( )}, such as two first peaks of the two adjacent antennas {Ant( )} among the multiple antennas {Ant( )}, to determine the AoA of the aforementioned any signal. For brevity, similar descriptions for these embodiments are not repeated in detail here.

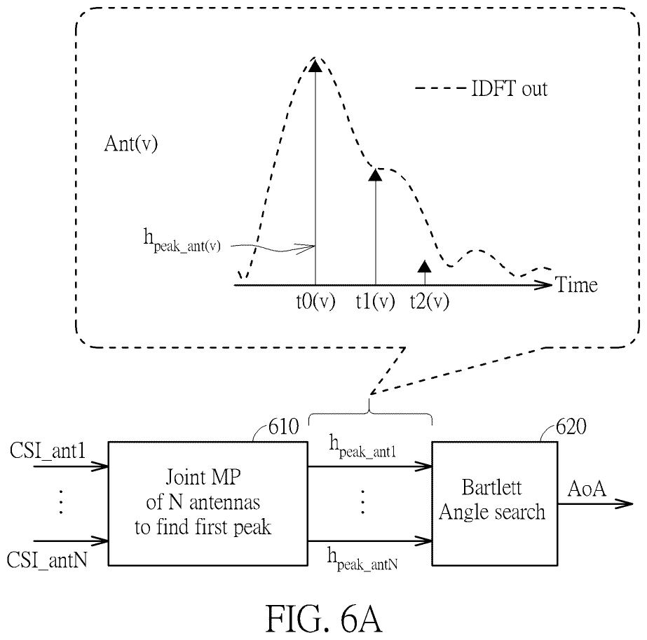

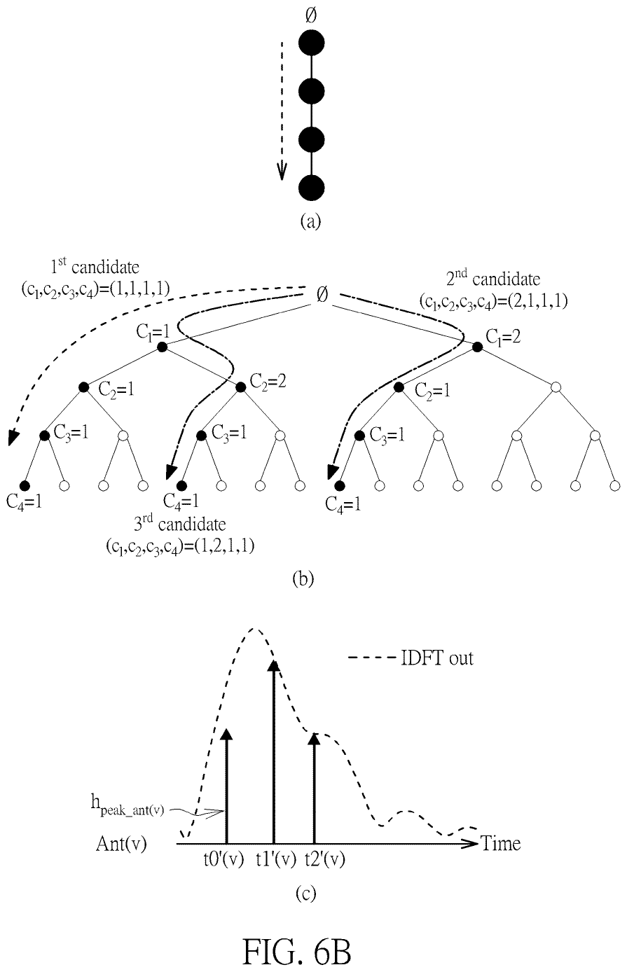

FIG. 6A illustrates an AoA information generation control scheme of the method according to an embodiment of the present invention. During finding the respective first peaks of the multiple antennas {Ant( )} of the antenna array 500 since the first detection start time point, the wireless transceiver device #k such as the non-AP STA device 120 may find the respective first peaks of the multiple antennas {Ant( )} of the antenna array 500 since the first detection start time point according to a first predetermined algorithm such as a time of arrival (ToA) joint matching pursuit (MP) algorithm, for example, by using a first program module 610 such as a joint MP module running on the non-AP STA device 120 (or the communication control circuit 124 therein) for finding the first peaks {h_{peak_ant(1)}, . . . , h_{peak_ant(N)}} (or “the first peaks {h_{peak_ant1}, . . . , h_{peak_antN}}”) of the N antennas {Ant(1), . . . , Ant(N)} according to the respective CSI {CSI_ant(1), . . . , CSI_ant(N)} (or “the respective CSI {CSI_ant1, . . . , CSI_antN}”) of the N antennas {Ant(1), . . . , Ant(N)} (labeled “Joint MP of N antennas to find first peak” for brevity). The first program module 610 may refer to the CSI CSI_ant(v) of any antenna Ant(v) among the antennas {Ant(v)|v=1, . . . , N} to find a series of peaks at a series of time points {t0(v), t1(v), t2(v), . . . } and find the first peak h_{peak_ant(v)} at the time point t0(v) among the series of peaks at a series of time points {t0(v), t1(v), t2(v), . . . }, where a curve corresponding to an inverse discrete Fourier transform (IDFT) output (or “the IDFT out”) may be illustrated for the antenna Ant(v) as shown in the upper half part of FIG. 6A for better comprehension, but the present invention is not limited thereto. More particularly, when v=1, the first program module 610 may find the first peak h_{peak_ant(1)} at the time point t0(1) among a series of peaks at a series of time points {t0(1), t1(1), t2(1), . . . }, and the rest may be deduced by analogy, for example, when v=N, the first program module 610 may find the first peak h_{peak_ant(N)} at the time point t0(N) among a series of peaks at the series of time points {t0(N), t1(N), t2(N), . . . }. The first-peak (e.g., the first peak h_{peak_ant(v)} at the time point t0(v)) found in a first-peak finding operation of the first program module 610 may correspond to a line-of-sight (LOS) path, but the present invention is not limited thereto. In addition, during finding the phase shift between the two first peaks of the two adjacent antennas {Ant( )} among the multiple antennas {Ant( )} to determine the AoA of the aforementioned any signal, the wireless transceiver device #k such as the non-AP STA device 120 may find the phase shift between the two first peaks of the two adjacent antennas {Ant( )} among the multiple antennas {Ant( )} to determine the AoA of the aforementioned any signal according to a second predetermined algorithm such as a Bartlett search algorithm, for example, by using a second program module 620 such as a Bartlett angle search module running on the non-AP STA device 120 (or the communication control circuit 124 therein) for determining the AoA according to the first peaks {h_{peak_ant(1)}, . . . , h_{peak_ant(N)}} of the N antennas {Ant(1), . . . , Ant(N)} (labeled “Bartlett Angle search” for brevity).

FIG. 6B illustrates, in the sub-diagrams (a) and (b) thereof, some examples of respective operations of multiple MP algorithms applicable to the first-peak finding operation of the AoA information generation control scheme shown in FIG. 6A, and further illustrates, in the sub-diagram (c) thereof, another example of the first-peak finding operation. Among various MP algorithms, a first MP algorithm such as the ToA joint MP algorithm and a second MP algorithm such as the joint multipath MP algorithm may operate in different manners as shown in the sub-diagrams (a) and (b), respectively, in order to find the first peak in first-peak finding operation, respectively, where the paths indicated by the arrows depicted with dashed lines may represent the associated finding/searching paths, starting from their beginning node (labeled “∅” for brevity), respectively. For example, in the second MP algorithm shown in the sub-diagram (b), assuming that there may exist one-to-one correspondence between the candidate order and the set of layer/iteration orders (c₁, c₂, c₃, c₄), multiple candidates such as the first (1^{st}) candidate, the second (2^{nd}) candidate and the third (3^{rd}) candidate may correspond to (c₁, c₂, c₃, c₄)=(1, 1, 1, 1), (c₁, c₂, c₃, c₄)=(2, 1, 1, 1) and (c₁, c₂, c₃, c₄)=(1, 2, 1, 1), respectively. In addition, when the first predetermined algorithm corresponding to the first program module 610 is implemented with the second MP algorithm such as the joint multipath MP algorithm, the example of the first-peak finding operation as shown in the upper half part of FIG. 6A may be replaced with the other example of the first-peak finding operation as shown in the sub-diagram (c) of FIG. 6B. As the associated timing of the peaks may vary with respect to the MP algorithm that is currently used, the series of peaks at the series of time points {t0(v), t1(v), t2(v), . . . } and the first peak h_{peak_ant(v)} at the time point t0(v) that is found therefrom may be may be replaced with a series of peaks at a series of time points {t0′(v), t1′(v), t2′(v), . . . } and the first peak h_{peak_ant(v)} at the time point t0′(v) that is found therefrom, respectively. When v=1, the first program module 610 may find the first peak h_{peak_ant(1)} at the time point t0′(1) among a series of peaks at a series of time points {t0′(1), t1′(1), t2′(1), . . . }, and the rest may be deduced by analogy, for example, when v=N, the first program module 610 may find the first peak h_{peak_ant(N)} at the time point t0′(N) among a series of peaks at the series of time points {t0′(N), t1′(N), t2′(N), . . . }. The first-peak (e.g., the first peak h_{peak_ant(v)} at the time point t0′(v)) found in the first-peak finding operation of the first program module 610 may correspond to a LOS path, but the present invention is not limited thereto.

According to some embodiments, the wireless transceiver device #k such as the non-AP STA device 120 may utilize the second program module 620 such as the Bartlett angle search module to perform Bartlett beamforming with an array processing for the antenna array 500 to spatially filter signals arriving from different directions, in order to determine the AoA corresponding to the direction from which the incident signal arrives at the antenna array 500, and more particularly, recover the desired signal based on the AoA and/or find the direction relative to the array where the source of the incident signal is located. For example, during the above processing, the wireless transceiver device #k such as the non-AP STA device 120 (or the second program module 620 therein such as the Bartlett angle search module) may magnify the signal from a certain direction by performing compensation on the phase shift. For brevity, similar descriptions for these embodiments are not repeated in detail here.

According to some embodiments, the first program module 610 and the first predetermined algorithm thereof and/or the second program module 620 and the second predetermined algorithm thereof may vary. For example, the first predetermined algorithm may represent any MP algorithm among a plurality of MP algorithms, and the second predetermined algorithm may represent any AoA estimation algorithm among a plurality of AoA estimation algorithms. Examples of the plurality of MP algorithms may include, but are not limited to: the ToA joint MP algorithm, the joint multipath MP algorithm, etc. Examples of the plurality of AoA estimation algorithms may include, but are not limited to: the Delay and Sum algorithm (also known as the Bartlett algorithm), the Minimum Variance Distortionless (MVDR) algorithm (also known as the Capon algorithm), the multiple signal classification (MUSIC) algorithm, etc.

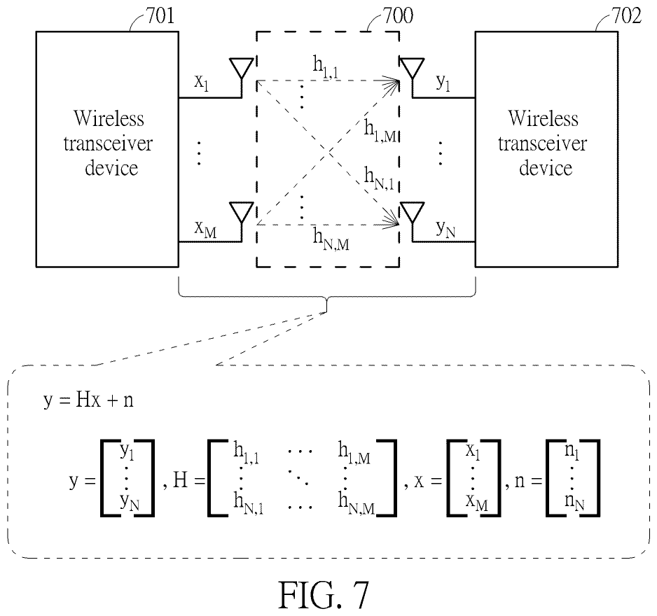

FIG. 7 illustrates a CSI model involved with the method according to an embodiment of the present invention. For example, regarding a transmitter such as the wireless transceiver device 701 and a receiver such as the wireless transceiver device 702 in the communication system shown in FIG. 7, the received signal y may be expressed with the following equation:

$$y = Hx + n ;$$

where “H” may represent a complex matrix, “x” may represent the transmitted signal, and “n” may represent the noise. As shown in the upper half part of FIG. 7, the CSI 700 may be arranged to describe how the signal will be transmitted from the transmitter such as the wireless transceiver device 701 to the receiver such as the wireless transceiver device 702. The wireless transceiver device 702 may perform channel estimation according to the long training field (LTF) in the PHY preamble of the received signal y respectively received via the multiple antennas {Ant( )} thereof to generate a CSI matrix for indicating the channel state. Taking the non-AP STA device 120 equipped with the antenna array 500 shown in FIG. 5 as an example of the wireless transceiver device 702 shown in FIG. 7, the multiple antennas {Ant( )} of the wireless transceiver device 702 may comprise the N antennas {Ant(1), . . . , Ant(N)} within the antenna array 500. In addition, the CSI may be expressed with an N×M matrix having complex values as the elements thereof, such as the complex matrix H in this equation.

As shown in the lower half part of FIG. 7, the transmitted signal x may comprise M sub-signals such as the signals {x₁, . . . , x_{M}}, the complex matrix H may comprise (N*M) elements {h} such as the elements {{h_{1,1}, . . . , h_{1,M}}, . . . , {h_{N,1}, . . . , h_{N,M}}}, all of which are complex values, the noise n may comprise N noise components such as the noise components {n₁, . . . , n_{N}}, and the received signal y may comprise N sub-signals such as the signals {y₁, . . . , y_{N}}, where “M” may represent the antenna count of the transmitter such as the wireless transceiver device 701, and “N” may represent the antenna count of the receiver such as the wireless transceiver device 702. In each complex value among these complex values, the real part may be arranged to describe the amplitude variance and the imaginary part may be arranged to describe the phase variance. As the CSI 700 may represent the channel state, and the activities in the space (or channel) may affect the channel state, it is possible to correlate the activities and the CSI. For example, any other device among the aforementioned at least one other device, such as any AP device 110 among the aforementioned at least one AP device 110 acting as the aforementioned at least one transmitter TX[i], may play the role of the wireless transceiver device 701 to transmit the transmitted signal x (e.g., the second communication frame 228 being transmitted), and the wireless transceiver device #k such as the non-AP STA device 120 may play the role of the wireless transceiver device 702 to receive the received signal y, and more particularly, determine the respective CSI {CSI_ant(1), . . . , CSI_ant(N)} of the N antennas {Ant(1), . . . , Ant(N)} based on the CSI model shown in FIG. 7, for being input into the first program module 610 (e.g., the joint MP module) shown in FIG. 6A to operate according to the AoA information generation control scheme.

For the case of M>1, as the wireless transceiver device 701 may perform wireless transmission with M antennas, respectively, the aforementioned CSI CSI_ant(v) of the aforementioned any antenna Ant(v) among the antennas {Ant(v)|v=1, . . . , N}, such as any CSI among the respective CSI {CSI_ant(1), . . . , CSI_ant(N)} of the N antennas {Ant(1), . . . , Ant(N)}, should be determined with respect to the M antennas of the wireless transceiver device 701, respectively, and therefore may be written as the CSI {CSI_ant(v, u)|v=1, . . . , N; u=1, . . . , M}. The wireless transceiver device #k such as the non-AP STA device 120 that is playing the role of the wireless transceiver device 702 may calculate the N antennas' h power (or the respective h power of the N antennas {Ant(1), . . . , Ant(N)}) such as the respective amplitudes or absolute values {{|h_{1,1}|, . . . , |h_{1,M}|}, . . . , {|h_{N,1}|, . . . , |h_{N,M}|}} of the elements {{h_{1,1}, . . . , h_{1,M}}, . . . , {h_{N,1}, . . . , h_{N,M}}} to be the CSI {CSI_ant(v, u)|v=1, . . . , N; u=1, . . . , M} as follows:
CSI_ant(v, u)=|h_{v,u}|;
where v=1, . . . , or N, and u=1, . . . , or M. That is, {{CSI_ant(1, 1), . . . , CSI_ant(1, M)}, . . . , {CSI_ant(N, 1), . . . , CSI_ant(N, M)}}={{|h_{1,1}|, . . . , |h_{1,M}|}, . . . , {|h_{N,1}|, . . . , |h_{N,M}|}}. For the case of M=1, the aforementioned CSI CSI_ant(v) of the aforementioned any antenna Ant(v) among the antennas {Ant(v)|v=1, . . . , N} may be expressed as follows:
CSI_ant(v)=CSI_ant(v, u=1)=|h_{v,1}|;
where v=1, . . . , or N. In this case, {CSI_ant(1), . . . , {CSI_ant(N)}={|h_{1,1}|, . . . , |h_{N,1}|}.

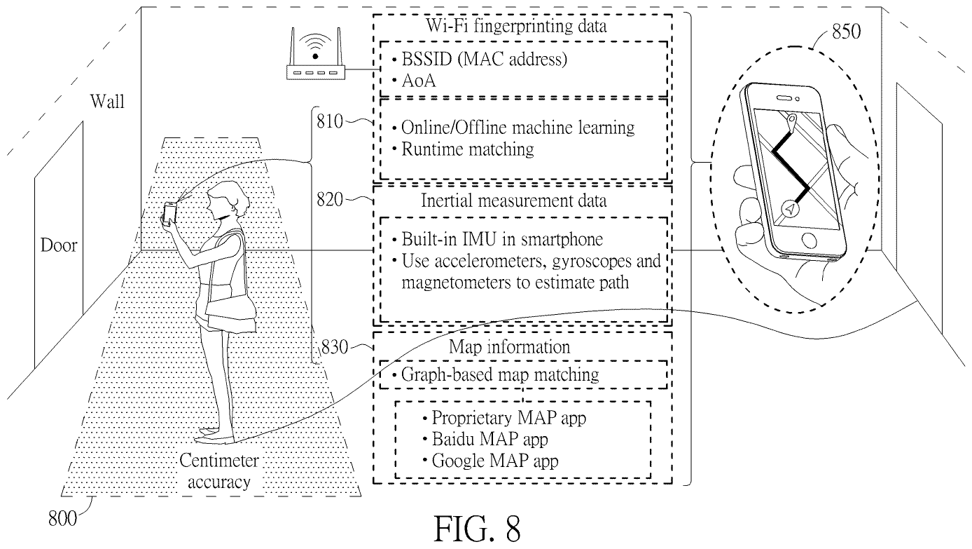

FIG. 8 illustrates some key features of a fusion indoor location system involved with the method according to an embodiment of the present invention. The wireless transceiver device #k such as the non-AP STA device 120 may perform fusion indoor estimation according to the Wi-Fi fingerprinting data 810, the inertial measurement data 820 and the map information 830 to achieve the centimeter accuracy 800, in order to provide a seamless positioning service 850 which may extend from outdoor positioning to indoor positioning. For example, the Wi-Fi fingerprinting data 810 may comprise the basic service set identifier (BSSID) such as the medium access control (MAC) address of the aforementioned any AP device 110 among the aforementioned at least one AP device 110 acting as the aforementioned at least one transmitter TX[i]), as well as the AoA, and may be collected with online/offline machine learning and runtime matching. In addition, the inertial measurement data 820 may be obtained from at least one built-in inertial measurement unit (IMU) in the multifunctional mobile phone such as the smartphone, and the IMU may be implemented by using multiple accelerometers (e.g., three accelerometers respectively corresponding to three directions of three axes such as the X-axis, the Y-axis and the Z-axis), multiple gyroscopes (e.g., three gyroscopes respectively corresponding to the three directions) and multiple magnetometers (e.g., three magnetometers respectively corresponding to the three directions) to allow the non-AP STA device 120 to estimate the moving or walking path of the user. Additionally, the non-AP STA device 120 may refer to the map information 830 to perform graph-based map matching to provide the seamless positioning service 850 to the user via at least one map application (or “the MAP app”). Examples of the MAP app may include, but are not limited to: a proprietary MAP app, a Baidu MAP app and a Google MAP app. For brevity, similar descriptions for this embodiment are not repeated in detail here.

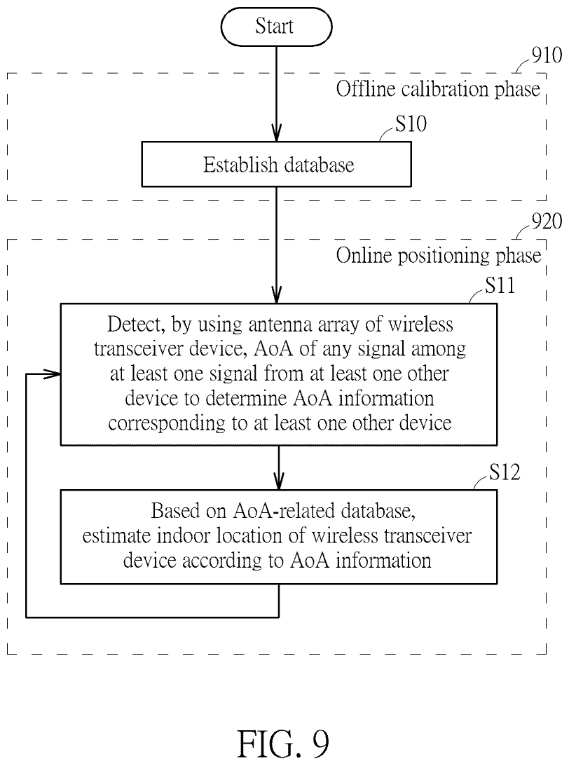

FIG. 9 illustrates a working flow of the method according to an embodiment of the present invention, where the offline calibration phase 910 and the online positioning phase 920 shown in FIG. 9 may be taken as examples of the offline calibration phase and the online positioning phase mentioned above, respectively.

In the offline calibration phase 910, the wireless transceiver device #k (e.g., the non-AP STA device 120) may establish the AoA-related database 230 in Step S10.

In the online positioning phase 920, the wireless transceiver device #k (e.g., the non-AP STA device 120) may detect, by using the antenna array (e.g., the antenna array 500) of the wireless transceiver device #k, the AoA of the aforementioned any signal among the aforementioned at least one signal from the aforementioned at least one other device (e.g., the aforementioned at least one AP device 110) to determine the AoA information corresponding to the aforementioned at least one other device in Step S11, and may, based on the AoA-related database 230, estimate, the indoor location (e.g., the current indoor location X) of the wireless transceiver device #k according to the AoA information in Step S12.

More particularly, the AoA-related database 230 may be established with respect to the multiple predetermined indoor locations such as the J predetermined indoor locations {Grid(1), Grid(2), . . . , Grid(J)}. Regarding the aforementioned any predetermined indoor location among the multiple predetermined indoor locations, such as the aforementioned any predetermined indoor location Grid(j) among the J predetermined indoor locations {Grid(1), Grid(2), . . . , Grid(J)}, the AoA-related database 230 may comprise one or the combination of the aforementioned at least one AoA of the aforementioned at least one first signal and the aforementioned at least one feature extracted from the aforementioned at least one AoA of the aforementioned at least one first signal. In addition, if the AoA-related database 230 comprises the aforementioned at least one AoA of the aforementioned at least one first signal, the AoA information may comprise the aforementioned at least one AoA of the aforementioned at least one second signal; and if the AoA-related database 230 comprises the aforementioned at least one feature extracted from the aforementioned at least one AoA of the aforementioned at least one first signal, the AoA information may comprise the aforementioned at least one feature extracted from the aforementioned at least one AoA of the aforementioned at least one second signal. For brevity, similar descriptions for this embodiment are not repeated in detail here.

For better comprehension, the method may be illustrated with the working flow shown in FIG. 9, but the present invention is not limited thereto. According to some embodiments, one or more steps may be added, deleted, or changed in the working flow shown in FIG. 9. For example, a breakpoint for exiting from the loop comprising Steps S11 and S12 may be inserted into the partial working flow from Step S12 to Step S11. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing indoor location estimation with angle of arrival (AoA) information in a wireless communication system, wherein a wireless transceiver device is capable of detecting at least one signal from at least one other device in the wireless communication system, the method comprising:
in an online positioning phase among multiple phases of the wireless transceiver device, detecting, by using an antenna array of the wireless transceiver device, an AoA of any signal among the at least one signal from the at least one other device to determine the AoA information corresponding to the at least one other device; and
in the online positioning phase, based on an AoA-related database, estimating an indoor location of the wireless transceiver device according to the AoA information, wherein the AoA-related database is established in an offline calibration phase, the offline calibration phase prior to the online positioning phase, among the multiple phases of the wireless transceiver device.

2. The method of claim 1, wherein the at least one other device comprises multiple other devices, and the at least one signal comprises multiple signals detected in the online positioning phase.

3. The method of claim 2, wherein the AoA information comprises one or a combination of respective angles of arrival (AoAs) of the multiple signals and a set of features extracted from the respective AoAs of the multiple signals.

4. The method of claim 2, wherein the multiple signals detected in the online positioning phase represent multiple second signals; the AoA-related database is established with respect to multiple predetermined indoor locations; and regarding any predetermined indoor location among the multiple predetermined indoor locations, the AoA-related database comprises one or a combination of respective angles of arrival (AoAs) of multiple first signals from the multiple other devices and a set of features extracted from the respective AoAs of the multiple first signals.

5. The method of claim 4, wherein:
if the AoA-related database comprises the respective AoAs of the multiple first signals, the AoA information comprises the respective AoAs of the multiple second signals; and
if the AoA-related database comprises the set of features extracted from the respective AoAs of the multiple first signals, the AoA information comprises a set of features extracted from the respective AoAs of the multiple second signals.

6. The method of claim 1, wherein the AoA information comprises one or a combination of the AoA of the any signal and a feature extracted from the AoA of the any signal.

7. The method of claim 1, wherein the at least one signal detected in the online positioning phase represents at least one second signal; the AoA-related database is established with respect to multiple predetermined indoor locations; and regarding any predetermined indoor location among the multiple predetermined indoor locations, the AoA-related database comprises one or a combination of at least one AoA of at least one first signal from the at least one other device and at least one feature extracted from the at least one AoA of the at least one first signal.

8. The method of claim 7, wherein:
if the AoA-related database comprises the at least one AoA of the at least one first signal, the AoA information comprises at least one AoA of the at least one second signal; and
if the AoA-related database comprises the at least one feature extracted from the at least one AoA of the at least one first signal, the AoA information comprises at least one feature extracted from the at least one AoA of the at least one second signal.

9. The method of claim 1, wherein detecting, by using the antenna array of the wireless transceiver device, the AoA of the any signal among the at least one signal from the at least one other device to determine the AoA information corresponding to the at least one other device further comprises:
finding respective first peaks of multiple antennas of the antenna array since a first detection start time point according to a first predetermined algorithm; and
finding a phase shift between at least two first peaks of at least two antennas among the multiple antennas to determine the AoA of the any signal according to a second predetermined algorithm.

10. The method of claim 1, wherein the AoA-related database is established in the offline calibration phase in advance for being used by the wireless transceiver device in the online positioning phase.

11. A wireless transceiver device, for performing indoor location estimation with angle of arrival (AoA) information in a wireless communication system, the wireless transceiver device comprising:
a processing circuit, arranged to control operations of the wireless transceiver device; and
at least one communication control circuit, coupled to the processing circuit, arranged to perform communication control, wherein the at least one communication control circuit is arranged to perform wireless communication operations within the wireless communication system for the wireless transceiver device, wherein the wireless transceiver device is capable of detecting at least one signal from at least one other device in the wireless communication system;
wherein:
in an online positioning phase among multiple phases of the wireless transceiver device, the wireless transceiver device is arranged to detect, by using an antenna array of the wireless transceiver device, an AoA of any signal among the at least one signal from the at least one other device to determine the AoA information corresponding to the at least one other device; and
in the online positioning phase, based on an AoA-related database, the wireless transceiver device is arranged to estimate an indoor location of the wireless transceiver device according to the AoA information, wherein the AoA-related database is established in an offline calibration phase, the offline calibration phase prior to the online positioning phase, among the multiple phases of the wireless transceiver device.

12. The wireless transceiver device of claim 11, wherein the at least one other device comprises multiple other devices, and the at least one signal comprises multiple signals detected in the online positioning phase.

13. The wireless transceiver device of claim 12, wherein the AoA information comprises one or a combination of respective angles of arrival (AoAs) of the multiple signals and a set of features extracted from the respective AoAs of the multiple signals.

14. The wireless transceiver device of claim 12, wherein the multiple signals detected in the online positioning phase represent multiple second signals; the AoA-related database is established with respect to multiple predetermined indoor locations; and regarding any predetermined indoor location among the multiple predetermined indoor locations, the AoA-related database comprises one or a combination of respective angles of arrival (AoAs) of multiple first signals from the multiple other devices and a set of features extracted from the respective AoAs of the multiple first signals.

15. The wireless transceiver device of claim 14, wherein:
if the AoA-related database comprises the respective AoAs of the multiple first signals, the AoA information comprises the respective AoAs of the multiple second signals; and
if the AoA-related database comprises the set of features extracted from the respective AoAs of the multiple first signals, the AoA information comprises a set of features extracted from the respective AoAs of the multiple second signals.

16. The wireless transceiver device of claim 11, wherein the AoA information comprises one or a combination of the AoA of the any signal and a feature extracted from the AoA of the any signal.

17. The wireless transceiver device of claim 11, wherein the at least one signal detected in the online positioning phase represents at least one second signal; the AoA-related database is established with respect to multiple predetermined indoor locations; and regarding any predetermined indoor location among the multiple predetermined indoor locations, the AoA-related database comprises one or a combination of at least one AoA of at least one first signal from the at least one other device and at least one feature extracted from the at least one AoA of the at least one first signal.

18. The wireless transceiver device of claim 17, wherein:
if the AoA-related database comprises the at least one AoA of the at least one first signal, the AoA information comprises at least one AoA of the at least one second signal; and
if the AoA-related database comprises the at least one feature extracted from the at least one AoA of the at least one first signal, the AoA information comprises at least one feature extracted from the at least one AoA of the at least one second signal.

19. The wireless transceiver device of claim 11, wherein during detecting the AoA of the any signal among the at least one signal from the at least one other device to determine the AoA information corresponding to the at least one other device, the wireless transceiver device is arranged to find respective first peaks of multiple antennas of the antenna array since a first detection start time point according to a first predetermined algorithm, and find a phase shift between at least two first peaks of at least two antennas among the multiple antennas to determine the AoA of the any signal according to a second predetermined algorithm.

20. The wireless transceiver device of claim 11, wherein the AoA-related database is established in the offline calibration phase in advance for being used by the wireless transceiver device in the online positioning phase.
